(19) United States
(12) Patent Application Publication
(10) Pub. No.: US 2010/0245065 A1
(43) Pub. Date: Sep. 30, 2010

(54) Obstacle detection apparatus and method of controlling obstacle detection apparatus

(75) Inventors: Taketo Harada, Obu-city (JP); Muneaki Matsumoto, Okazaki-city (JP); Yasuhiro Kawashima, Okazaki-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/661,506

(22) Filed: Mar. 18, 2010

(30) Foreign Application Priority Data
Mar. 25, 2009 (JP) 2009-074565

(51) Int. Cl. B60Q 1/00

(52) U.S. Cl. 340/435

(57) ABSTRACT

An obstacle detection apparatus includes first and second ultrasonic sensors, a control part, and a warning device for warning in accordance with a distance between at least one of the ultrasonic sensors and an obstacle. The control part sets the first ultrasonic sensor to a transmitting and receiving mode while setting the second ultrasonic sensor to a receiving mode, and then sets the first ultrasonic sensor to the receiving mode while setting the second ultrasonic sensor to the transmitting and receiving mode. Each of the ultrasonic sensors has a reception sensitivity to a reflected wave reflected by the obstacle. Each of the ultrasonic sensors includes a reception sensitivity control portion configured to increase the reception sensitivity when the receiving mode is set compared with when the transmitting and receiving mode is set.

### CROSS REFERENCE TO RELATED APPLICATIONS

The present application is based on and claims priority to Japanese Patent Applications No. 2009-74565 filed on Mar. 25, 2009, the contents of which are incorporated in their entirety herein by reference.

### BACKGROUND OF THE INVENTION

1. Field of the Invention

The present invention relates to an obstacle detection apparatus including a plurality of ultrasonic sensors. The present invention also relates to a method of controlling an obstacle detection apparatus including a plurality of ultrasonic sensors.

2. Description of the Related Art

Conventionally, an obstacle detection apparatus is used for detecting an obstacle in the vicinity of a vehicle, as described, for example, in US 2007/0291590A (corresponding to JP-A-2007-333609). The obstacle detection apparatus includes an ultrasonic sensor disposed, for example, at a bumper of a vehicle. The obstacle detection apparatus detects an obstacle in the vicinity of the vehicle with the ultrasonic sensor and warns to a driver of the vehicle. The obstacle detection apparatus measures a time from when an ultrasonic wave is transmitted from the ultrasonic sensor till when the ultrasonic wave reflected by an obstacle is received, calculates a distance from the ultrasonic sensor to the obstacle based on the measured time, and warns when the calculated distance is shorter than a predetermined distance.

An example of a conventional obstacle detection apparatus includes two ultrasonic sensors respectively disposed at a right side and a left side of a vehicle and detects an obstacle by the two ultrasonic sensors as shown in FIGS. 10A and 10B.

The obstacle detection apparatus shown in FIG. 10A includes a first ultrasonic sensor 2a disposed at a right side of the vehicle and a second ultrasonic sensor 2b disposed at a left side of the vehicle. The first ultrasonic sensor 2a has a detection area Da, and the second ultrasonic sensor 2b has a detection area Db. The obstacle detection apparatus detects an obstacle in the detection areas Da and Db. Then, the obstacle detection apparatus outputs a warning sound in accordance with a distance from each of the ultrasonic sensors 2a and 2b to the obstacle. For example, arcs centering on each of the ultrasonic sensors 2a and 2b are determined as boundaries, and the different warning sounds, for example, a continuous sound (CS), a first intermittent sound (IS1), a second intermittent sound (IS2), and a third intermittent sound (IS3) are used in the order of the distance from each of the ultrasonic sensors 2a and 2b. When an obstacle is in areas D1a or D1b where detection area Da of the first ultrasonic sensor 2a and detection area Db of the second ultrasonic sensor 2b do not overlap, the obstacle detection apparatus can output the warning sound in accordance with the distance from one of the ultrasonic sensors 2a and 2b to the obstacle. However, in an area D2 where detection areas Da and Db overlap, the boundaries defined by the arcs centering on the first ultrasonic sensor 2a do not correspond the boundaries defined by the arcs centering on the second ultrasonic sensor 2b. Thus, when an obstacle is in the same position in the area D2, the obstacle detection apparatus may output different warning sounds, and the obstacle detection apparatus is difficult to change the waning sound smoothly.

In the obstacle detection apparatus shown in FIG. 10B, the first ultrasonic sensor 2a is set to a transmitting and receiving mode, and the second ultrasonic sensor 2b is set to a receiving mode. Then, a distance from the first ultrasonic sensor 2a to an obstacle and a distance from the obstacle to the second ultrasonic sensor 2b are detected. The obstacle detection apparatus can detect the distance to the obstacle by regarding the first ultrasonic sensors 2a and the second ultrasonic sensor 2b as two centers of ellipses. Thus, the obstacle detection apparatus detects a position of an obstacle in the area D2 and compensates a change of the warning sound based on the detected position.

Although the above-described obstacle detection apparatus specifies a position of an obstacle in the area D2 between the two ultrasonic sensors 2a and 2b for compensating the change of the warning sound, a ratio of the area D2 to the total detection area is small. In other words, most area of the total detection area is the areas D1a and D1b where an obstacle is detected by only one of the ultrasonic sensors 2a and 2b. Therefore, the above-described obstacle detection apparatus is difficult to specify a position of an obstacle over a large area.

### SUMMARY OF THE INVENTION

In view of the foregoing problems, it is an object of the present invention to provide an obstacle detection apparatus that can detect a position of an obstacle by two ultrasonic sensors over a large area. Another object of the present invention to provide a method of controlling an obstacle detection apparatus that can detect a position of an obstacle by two ultrasonic sensors over a large area.

An obstacle detection apparatus according to an aspect of the present invention includes a first ultrasonic sensor, a second ultrasonic sensor, a control part, and a warning device. Each of the ultrasonic sensors includes a microphone. The microphone is configured so that the microphone transmits an ultrasonic wave and receives a reflected wave that is the ultrasonic wave reflected by an obstacle when a transmitting and receiving mode is set, and the microphone only receives the reflected wave when a receiving mode is set. Each of the ultrasonic sensors has a reception sensitivity to the reflected wave. Each of the ultrasonic sensors includes a reception sensitivity control portion configured to increase the reception sensitivity when the receiving mode is set compared with when the transmitting and receiving mode is set. The control part is configured so that the control part sets the first ultrasonic sensor to the transmitting and receiving mode while setting the second ultrasonic sensor to the receiving mode, and then sets the first ultrasonic sensor to the receiving mode while setting the second ultrasonic sensor to the transmitting and receiving mode. The warning device is configured to warn in accordance with a distance between at least one of the ultrasonic sensors and the obstacle.

In the above-described obstacle detection apparatus, one of the ultrasonic sensors is set to the transmitting and receiving mode, the other one of the ultrasonic sensors is set to the receiving mode, and the reception sensitivity of the other one of the ultrasonic sensors, which is set to the receiving mode, is increased compared with the reception sensitivity in the transmitting and receiving mode. Therefore, the obstacle detection apparatus can detect a position of an obstacle by the two ultrasonic sensors over a large area.

According to another aspect of the present invention, a method of controlling an obstacle detection apparatus including a first ultrasonic sensor and a second ultrasonic sensor is provided. In the method, the first ultrasonic sensor is set to a transmitting and receiving mode while the second ultrasonic sensor is set to a receiving mode so that the first ultrasonic sensor transmits a first ultrasonic wave and the first ultrasonic sensor and the second ultrasonic sensor receive a first reflected wave that is the first ultrasonic wave reflected by an obstacle. When the first ultrasonic sensor is to the transmitting and receiving mode, a reception sensitivity of the first ultrasonic sensor is to a first reception sensitivity for the transmitting and receiving mode. When the second ultrasonic sensor is set to the receiving mode, a reception sensitivity of the second ultrasonic sensor is set to a second reception sensitivity for the receiving mode. A distance from the first ultrasonic sensor to the obstacle is calculated based on a time from when the first ultrasonic wave is transmitted from the first ultrasonic sensor till when the first reflected wave is received by the first ultrasonic sensor, and a distance from the second ultrasonic sensor to the obstacle is calculated based on a time form when the first ultrasonic wave is transmitted from the first ultrasonic sensor till when the first reflected wave is received by the second ultrasonic sensor.

Next, the first ultrasonic sensor is to the receiving mode while the second ultrasonic sensor is set to the transmitting and receiving mode so that the second ultrasonic sensor transmits a second ultrasonic wave and the first ultrasonic sensor and the second ultrasonic sensor receive a second reflected wave that is the second ultrasonic wave reflected by the obstacle. When the first ultrasonic sensor is set to the receiving mode, the reception sensitivity of the first ultrasonic sensor is to a first reception sensitivity for the receiving mode. When the setting the second ultrasonic sensor is set to the transmitting and receiving mode, the reception sensitivity of the second ultrasonic sensor is to a second reception sensitivity for the transmitting receiving mode. A distance from the first ultrasonic sensor to the obstacle is calculated based on a time from when the second ultrasonic wave is transmitted from the second ultrasonic sensor till when the second reflected wave is received by the first ultrasonic sensor, and a distance from the second ultrasonic sensor to the obstacle based on a time form when the second ultrasonic wave is transmitted from the second ultrasonic sensor till when the second reflected wave is received by the second ultrasonic sensor. Then, a position of the obstacle is detected based on the distances. The first reception sensitivity for the receiving mode is higher than the first reception sensitivity for the transmitting and receiving mode, and the second reception sensitivity for the receiving mode is higher than the second reception sensitivity for the transmitting and receiving mode.

In the above-described method of controlling an obstacle detection apparatus, one of the ultrasonic sensors is set to the transmitting and receiving mode, the other one of the ultrasonic sensors is set to the receiving mode, and the reception sensitivity of the other one of the ultrasonic sensors is set to the reception sensitivity for the receiving mode that is higher than the reception sensitivity for the transmitting and receiving mode. Therefore, a position of an obstacle can be detected by the two ultrasonic sensors over a large area.

### BRIEF DESCRIPTION OF THE DRAWINGS

Additional objects and advantages of the present invention will be more readily apparent from the following detailed description of exemplary embodiments when taken together with the accompanying drawings. In the drawings:

FIG. 1 is a diagram showing an obstacle detection apparatus according to a first embodiment of the present invention;

FIG. 2 is a block diagram showing an ultrasonic sensor in the obstacle detection apparatus;

FIG. 3A and FIG. 3B are diagrams showing states where an obstacle is detected by the obstacle detection apparatus;

FIG. 4A is a diagram showing a total detection area of the obstacle detection apparatus according to the first embodiment and FIG. 4B is a diagram showing a total detection area of an obstacle detection apparatus according to a comparative example;

FIG. 5 is a flowchart showing an obstacle detection process executed by a control block in the ultrasonic sensor;

FIG. 6 is a diagram showing an example of operation sequences of the obstacle detection apparatus;

FIG. 7A to FIG. 7C are diagrams showing detection areas in cases where a sound pressure or a reception sensitivity of the ultrasonic sensors is different from a predetermined value;

FIG. 8A is a diagram showing an image of a total sensitivity compensation in a case where variations among products are not taken into consideration and

FIG. 8B is a diagram showing an image of a total sensitivity compensation of an obstacle detection apparatus according to a second embodiment of the present invention;

FIG. 9 is a diagram showing an initial operation of the obstacle detection apparatus according to the second embodiment; and

FIG. 10A and FIG. 10B are diagrams showing states of obstacle detection performed by obstacle detection apparatuses according to examples of the conventional art.

### DETAILED DESCRIPTION OF THE EXEMPLARY EMBODIMENTS

### First Embodiment

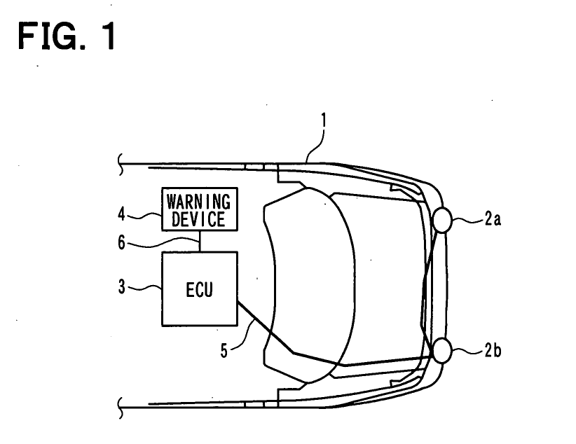

An obstacle detection apparatus according to a first embodiment of the present invention will be described with reference to FIG. 1.

The obstacle detection apparatus is disposed in a vehicle 1. The obstacle detection apparatus includes a first ultrasonic sensor 2a, a second ultrasonic sensor 2b, an electronic control unit (ECU) 3, and a warning device 4. Each of the ultrasonic sensors 2a and 2b is coupled with the ECU 3 through a local area network cable (LAN cable) 5 so as to be communicate with each other. The ECU 3 and the warning device 4 are coupled through a cable 6 so that the ECU 3 can transmit a warning command signal to the warning device 4.

The ultrasonic sensors 2a and 2b are fixed to vehicle parts such as bumpers on a front side and a rear side of the vehicle 1. In the present embodiment, the first ultrasonic sensor 2a is disposed on a right rear side of the vehicle 1 and the second ultrasonic sensor 2b is disposed on a left rear side of the vehicle 1. The ultrasonic sensors 2a and 2b operate based on command signals from the ECU 3 by a master-slave control method.

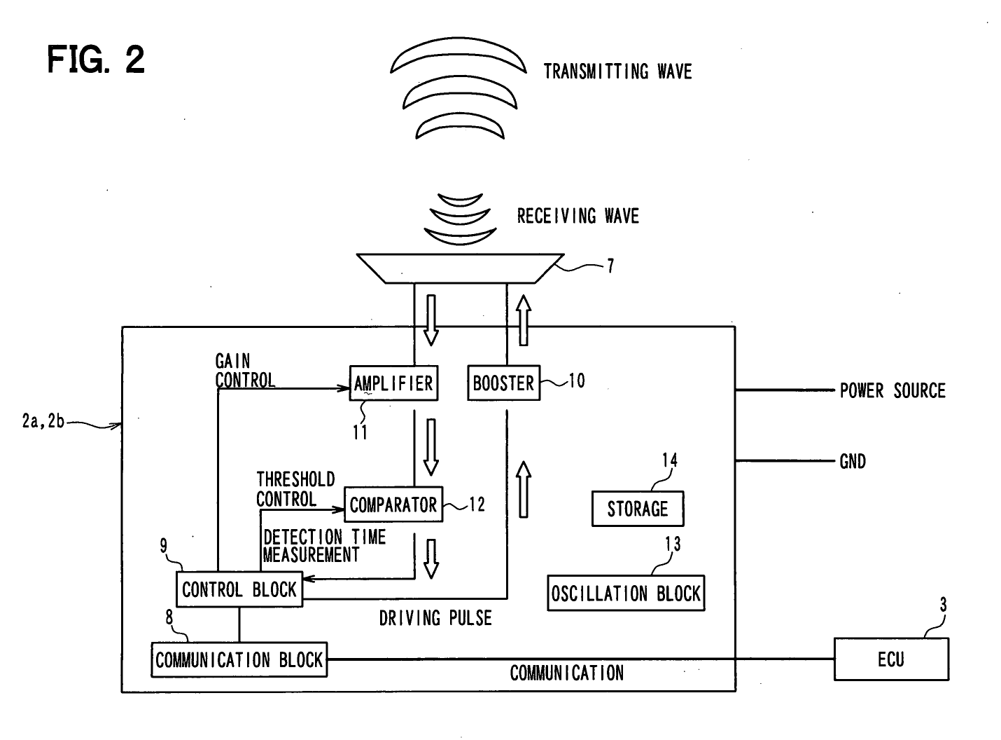

As shown in FIG. 2, each of the ultrasonic sensors 2a and 2b includes a microphone 7, a communication block 8, a control block 9, a booster circuit 10, an amplifier 11, a comparator 12, an oscillation block 13, and a storage medium 14.

The microphone 7 is configured to transmit a transmission wave and receive a reception wave. The microphone 7 includes an oscillator (not shown). The microphone 7 generates an ultrasonic wave as the transmission wave by ultrasonically oscillating the oscillator. Because the oscillator also oscillates when the oscillator receives an ultrasonic wave as the reception wave, the microphone 7 can detect the reception wave. A configuration and an operating principle of the microphone 7 are known. Therefore, a detailed description of the microphone 7 is omitted.

The communication block 8 communicates with the ECU 3. The communication block 8 receives a command signal from the ECU 3 and transmits the command signal to the control block 9. In addition, when the control block 9 transmits a response signal based on the command signal from the ECU 3, the communication block 8 receives the response signal and transmits the response signal to the ECU 3.

The control block 9 executes various processes for detecting an obstacle by the ultrasonic sensors 2a and 2b. Based on the command signal transmitted from the ECU 3 through the communication block 8, the control block 9 executes a process corresponding to the command signal. For example, the command signal includes a frame in which data indicating command content is stored. When the frame is transmitted from the ECU 3, the control block 9 reads the data stored in the frame and executes the process indicated by the data.

When an obstacle detection is performed, the control block 9 generates a driving pulse voltage. The booster circuit 10 boosts the driving pulse voltage. The driving pulse voltage boosted by the booster circuit 10 is applied to the microphone 7. Then, the oscillator in the microphone 7 ultrasonically oscillates and an ultrasonic wave is transmitted from the microphone 7.

When the microphone 7 transmits the ultrasonic wave and the microphone 7 receives the ultrasonic wave reflected by an obstacle as the reception wave, the amplifier 11 amplifies the reception wave with a predetermined gain. The gain of the amplifier 11 can be controlled by the control block 9.

The comparator 12 detects that the ultrasonic wave reflected by an obstacle is received by comparing a voltage of the reception wave amplified by the amplifier 11 with a predetermined threshold value. The threshold value can be controlled by the control block 9. When the voltage of the reception wave amplified by the amplifier 11 is greater than the threshold value, an output voltage of the comparator 12 transitions to a high level, and thereby the comparator 12 transmits that the reflected wave is received to the control block 9. Then, the control block 9 measures a detection time that corresponds to a time from when the transmission wave was transmitted till when the reflected wave was received and calculates a distance to the obstacle based on the detection time.

Since the obstacle detection is performed by comparing the reflected wave amplified by the amplifier 11 with the threshold value of the comparator 12, a reception sensitivity depends on the gain of the amplifier 11 and the threshold value of the comparator 12. The reception sensitivities of the ultrasonic sensors 2a and 2b are basically set in such a manner that the first ultrasonic sensor 2a and the second ultrasonic sensor 2b have the same obstacle detection range. The reception sensitivity can be controlled by controlling at least one of the gain of the amplifier 11 and the threshold value of the comparator 12. When the gain of the amplifier 11 is increased or when the threshold the comparator 12 is reduced, an obstacle can be detected even if an intensity of a reflected wave is low. Thus, the reception sensitivity increases and a detection area expands.

The oscillation block 13 generates a clock signal used for driving an integrated circuit including the control block 9. The storage medium 14 stores various data used for the obstacle detection. The control block 9 can read the data stored in the storage medium 14, and the control block 9 performs the obstacle detection based on the data.

The ECU 3 executes an obstacle detecting process when the vehicle 1 becomes a state where the obstacle detection is required, for example, when the vehicle 1 moves backward. The ECU 3 decides which one of the ultrasonic sensors 2a and 2b is set to a transmitting and receiving mode and which one of the ultrasonic sensors 2a and 2b is set to a receiving mode. Then, the ECU 3 transmits a frame that stores data indicating the operating mode of each of the ultrasonic sensors 2a and 2b. After the distance from each of the ultrasonic sensors 2a and 2b to an obstacle is detected, the ECU 3 transmits a frame that stores data requesting a calculation result of each of the ultrasonic sensors 2a and 2b. When the ECU 3 receives the calculation result from each of the ultrasonic sensors 2a and 2b, the ECU 3 outputs a control signal to the warning device 4 so that the warning device 4 outputs a warning sound in accordance with the distance to the obstacle.

The warning device 4 generates a warning sound such as a beep sound. The warning device 4 outputs different warning sounds based on the control signal of the ECU 3. For example, the warning device 4 uses a continuous sound, a first intermittent sound, a second intermittent sound, and a third intermittent sound in order of distance from the ECU 3. The first intermittent sound has a short interval, the second intermittent sound has an interval longer than the first intermittent sound, and the third intermittent sound has an interval longer than the second intermittent sound.

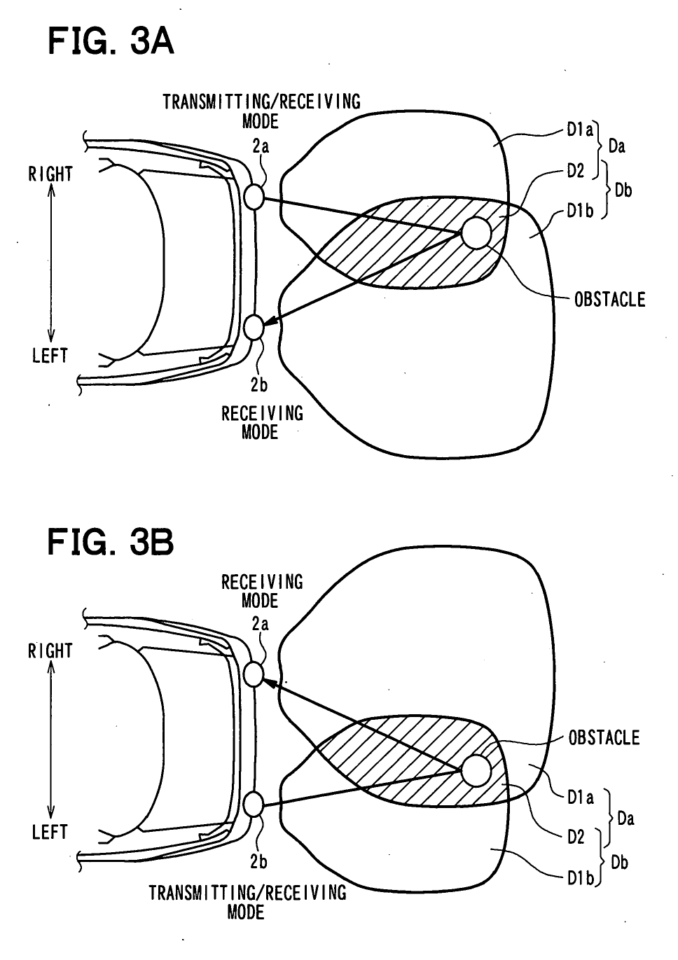

Next, a principle of detecting an obstacle by the obstacle detection apparatus according to present embodiment will be described with reference to FIG. 3.

In the present embodiment, one of the ultrasonic sensors 2a and 2b is set to the transmitting and receiving mode, and the other one of the ultrasonic sensors 2a and 2b is set to the receiving mode. Then, a distance from the one of the ultrasonic sensors 2a and 2b to the obstacle and the distance from the obstacle to the other one of the ultrasonic sensors 2a and 2b are measured. At the same time, the reception sensitivity of the other one of the ultrasonic sensors 2a and 2b that is set to the receiving mode is increased by controlling at least one of the gain of the amplifier 11 and the threshold value of the comparator 12.

For example, the first ultrasonic sensor 2a is set to the transmitting and receiving mode and the second ultrasonic sensor 2b is set to the receiving mode as shown in FIG. 3A, and the reception sensitivity of the second ultrasonic sensor 2b is increased from the initial state. Since the reception sensitivity of the first ultrasonic sensor 2a is not increased, a detection area Da of the first ultrasonic sensor 2a is an initial state. Since the reception sensitivity of the second ultrasonic sensor 2b is increased, a detection area Db of the second ultrasonic sensor 2b expands compared with an initial state. Thus, in the detection area Da of the first ultrasonic sensor 2a, an area D1a that does not overlap the detection area Db becomes smaller and an overlapping area D2 expands at a right side of the vehicle 1.

If the reception sensitivity of the first ultrasonic sensor 2a, which is set to the transmitting and receiving mode, is also increased to expand the detection area Da, reverberation, that is, a phenomenon where the transmission wave from the first ultrasonic sensor 2a is directly received expands. Therefore, a mask for the reverberation is provided so, that only the reflected wave is detected, and thereby a short distance detection accuracy may be reduced. However, in the obstacle detection apparatus according to the present embodiment, the reception sensitivity of the first ultrasonic sensor 2a is not increased. Thus, the reverberation can be restricted and a reduction of the short distance detection accuracy can be restricted. Although the detection area Db of the second ultrasonic sensor 2b expands, since the ultrasonic wave is transmitted from the first ultrasonic sensor 2a, the detection area Db does not expand in such a manner that the detection area Db hangs over the left side of the vehicle 1. When the first ultrasonic sensor 2a transmits the ultrasonic wave, a reflected wave is not received at a left portion of area D1b where the detection areas Da and Db do not overlap. Therefore, even if a sidewall exists on the left side of the vehicle 1, the obstacle detection apparatus does not detect the sidewall as an obstacle.

Next, the first ultrasonic sensor 2a is set to the receiving mode and the second ultrasonic sensor 2b is set to the transmitting and receiving mode as shown in FIG. 3B. The reception sensitivity of the first ultrasonic sensor 2a is increased and the reception sensitivity of the second ultrasonic sensor 2b is returned to the initial state. Since the reception sensitivity of the first ultrasonic sensor 2a is increased, the detection area Da of the first ultrasonic sensor 2a expands from the initial state. Since the reception sensitivity of the second ultrasonic sensor 2b is not increased, the detection area Db of the second ultrasonic sensor 2b becomes the initial state. Thus, in the detection area Db of the second ultrasonic sensor 2b, the area D1b that does not overlap the detection area Da becomes smaller and an overlapping area D2 expands at the left side of the vehicle 1.

In the present case, only the reception sensitivity of the first ultrasonic sensor 2a is increased and the reception sensitivity of the second ultrasonic sensor 2b is not increased. Therefore, in a manner similar to a case shown in FIG. 3A, the reverberation can be restricted and an issue that a sidewall is detected as an obstacle by error can be restricted.

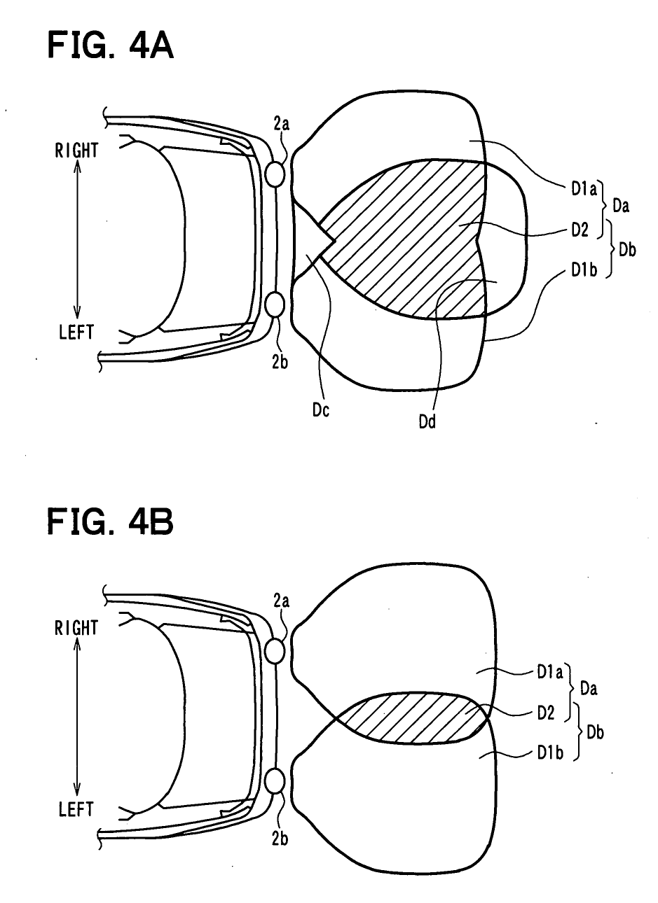

In the obstacle detection apparatus according to the present embodiment, one of the ultrasonic sensors 2a and 2b is set to the transmitting and receiving mode, and the other one of the ultrasonic sensors 2a and 2b is set to the receiving mode. The reception sensitivity of the other one of the ultrasonic sensors 2a and 2b, which is set to the receiving mode, is increased. Thus, the total detection area changes compared with the conventional obstacle detection apparatus. FIG. 4A and FIG. 4B are diagrams respectively showing the total detection areas of the obstacle detection apparatus according to the present embodiment and an obstacle detection apparatus according to a comparative example when the ultrasonic sensors 2a and 2b are set to the transmitting and receiving mode and the receiving mode alternately.

In the obstacle detection apparatus according to the comparative example, the reception sensitivity of each of the ultrasonic sensors 2a and 2b is not changed between the transmitting and receiving mode and the receiving mode in a manner similar to the conventional art. Therefore, the sum of the detection area Da of the first ultrasonic sensor 2a and the detection area Db of the second ultrasonic sensor 2b is the total detection area as shown in FIG. 4B. The areas D1a and D1b where the detection areas Da and Db do not overlap, that is, areas where a distance to an obstacle can be measured by only one of the ultrasonic sensors 2a and 2b and a position of the obstacle cannot be specified are large. The overlapping area D2, that is, an area where a distance to an obstacle can be measured by both the ultrasonic sensors 2a and 2b and a position of the obstacle can be specified is small.

In the obstacle detection apparatus according to the present embodiment, the reception sensitivity of one of the ultrasonic sensors 2a and 2b is increased when the one of the ultrasonic sensors 2a and 2b is set to the receiving mode. Thus, the overlapping area D2 of the detection areas Da and Db expands to a side of the other one of the ultrasonic sensors 2a and 2b, which is set to the transmitting and receiving mode, and the areas D1a and D1b where the detection areas Da and Db do not overlap become small. Since the detection area of the one of the ultrasonic sensors 2a and 2b, which is set to the receiving mode, expands, a short distance area Dc and a long distance area Dd, which cannot be detected by the obstacle detection apparatus according to the comparative example, are also included in the total detection area. Therefore, the area D2 where an obstacle can be detected by both the ultrasonic sensors 2a and 2b expands, and thereby the obstacle detection apparatus can detect a position of the obstacle over a large area.

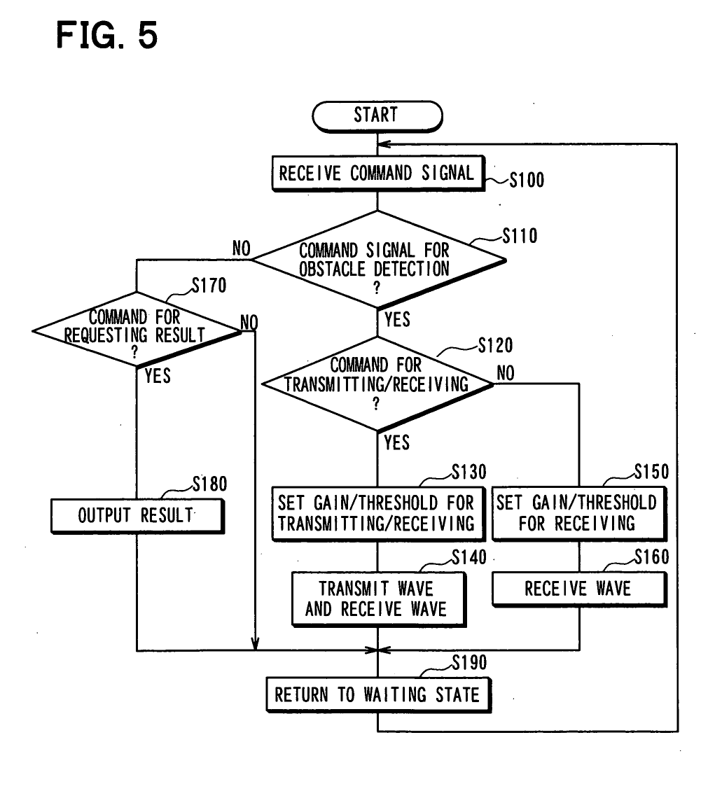

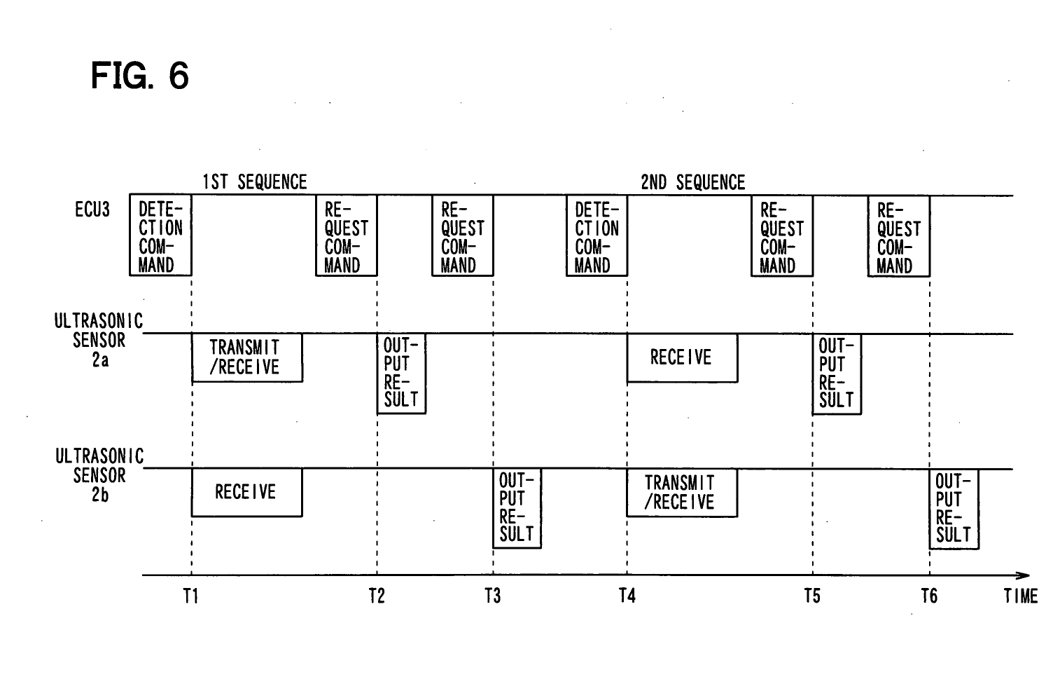

An operation method of the obstacle detection apparatus according to the present embodiment will be described with reference to FIG. 5 and FIG. 6

When an ignition switch (not shown) is turned on, each of the ultrasonic sensors 2a and 2b is applied with electricity, for example, from a battery and the control block 9 of each of the ultrasonic sensors 2a and 2b executes an obstacle detection process shown in FIG. 5.

Each of the ultrasonic sensors 2a and 2b is in a waiting state before receiving a command signal from the ECU 3. For example, when a gear shift is moved to a reverse position while the ignition switch is ON, the ECU 3 transmits a command signal. At S100, each of the ultrasonic sensors 2a and 2b receives the command signal from the ECU 3, and the process proceeds to S110.

At S110, the control block 9 determines whether the command signal from the ECU 3 is a command signal for the obstacle detection based on the data stored in the frame of the command signal. When the control block 9 determines that the command signal from the ECU 3 is the command signal for the obstacle detection, which corresponds to “YES” at S110, the process proceeds to S120.

At S120, the control block 9 determines whether the command signal indicates that the transmitting and receiving mode is to be set based on the data stored in the frame of the command signal. For example, the frame stores data that indicates “the ultrasonic sensor 2a: the transmitting and receiving mode, the ultrasonic sensor 2b: the receiving mode.” Thus, the control block 9 in each of the ultrasonic sensors 2a and 2b determines which mode is to be set based on the data.

When the control block 9 determines that the command signal indicates that the transmitting and receiving mode is to be set, which corresponds to “YES” at S120, the process proceeds to S130. At S130, the control block 9 sets the gain and the threshold value for the transmitting and receiving mode, that is, the gain and the threshold value in the initial state. At S140, the control block 9 outputs the driving pulse voltage to the microphone 7 so that the microphone 7 transmits an ultrasonic wave and the microphone 7 receives the ultrasonic wave reflected by an obstacle. Then, the control block 9 measures the detection time from when the microphone 7 transmitted the ultrasonic wave till when the microphone 7 received the reflected wave and calculates a distance to the obstacle based on the detection time. In this way, the distance from one of the ultrasonic sensors 2a, 2b that is set to the transmitting and receiving mode to the obstacle is measured.

When the control block 9 determines that the command signal indicates that the receiving mode is to be set, which corresponds to “NO” at S120, the process proceeds to S150. At S150, the control block 9 sets the gain and the threshold value for the receiving mode, that is, the control block 9 sets the gain and threshold value so that the reception sensitivity is increased compared with the reception sensitivity in the transmitting and receiving mode. Then, the process proceeds to S160. At S160, the microphone 7 receives the reflected wave of the ultrasonic wave transmitted from the microphone 7 of one of the ultrasonic sensors 2a and 2b that is set to the transmitting and receiving mode. Then, the control block 9 measures the detection time from when the ultrasonic wave was transmitted till when the reflected wave was received and calculates a distance to the obstacle based on the detection time. In this way, the distance from the other one of the ultrasonic sensors 2a, 2b that is set to the receiving mode to the obstacle is measured.

The distance from the first ultrasonic sensor 2a to the obstacle and the distance from the second ultrasonic sensor 2b to the obstacle are measured by the above-described way.

When the control block 9 determines that the command signal from the ECU 3 is a command signal that requests the detection result, which corresponds to “NO” at S110, the process proceeds to S170. At S170, the control block 9 determines whether the command signal indicates that the ECU 3 requests the own detection result. In other words, the control block 9 in the first ultrasonic sensor 2a determines whether the ECU 3 requests the detection result of the first ultrasonic sensor 2a, and the control block 9 in the second ultrasonic sensor 2b determines whether the ECU 3 requests the detection result of the second ultrasonic sensor 2b. When the control block 9 determines that the ECU 3 requests the own detection result, which corresponds to “YES” at S170, the process proceeds to S180 and outputs the detection result to the ECU 3. When the control block 9 determines that the ECU 3 does not request the own detection result, which corresponds “NO” at S170, the control block 9 does not respond.

After the process at each of S140, S160, and S180 is executed, the process proceeds to S190, and the control block 9 returns to the waiting state, and the control block 9 waits the command signal from the ECU 3.

Exemplary operation sequences of the obstacle detection by the obstacle detection apparatus according to the present embodiment will be described with reference to FIG. 6.

First, as a first sequence, the ECU 3 outputs the command signal for the obstacle detection. The frame of the command signal stores the data ordering that the first ultrasonic sensor 2a is set to the transmitting and receiving mode and the second ultrasonic sensor 2b is set to the receiving mode. The command signal is received by the first ultrasonic sensor 2a and the second ultrasonic sensor 2b at the same time. Thus, at time T1, the first ultrasonic sensor 2a and the second ultrasonic sensor 2b operate synchronously. The first ultrasonic sensor 2a transmits an ultrasonic wave and receives a reflected wave in a state where the gain and the threshold value for the transmitting and receiving mode are set. The second ultrasonic sensor 2b receives a reflected wave in a state where the gain and the threshold value for the receiving mode, that is, the gain and the threshold value for increasing the reception sensitivity are set.

When the ECU 3 outputs the command signal to request the detection result of the first ultrasonic sensor 2a, the first ultrasonic sensor 2a outputs the detection result at time T2. When the ECU 3 outputs the command signal to request the detection result of the second ultrasonic sensor 2b, the second ultrasonic sensor 2b outputs the detection result at time T3. Thus, the ECU 3 can detect the distances from each of the ultrasonic sensors 2a and 2b to the obstacle in a case where the ultrasonic wave is transmitted from the first ultrasonic sensor 2a.

Next, as a second sequence, the ECU 3 outputs the command signal for the obstacle detection. The frame of the command signal stores the data ordering that the first ultrasonic sensor 2a is set to the receiving mode and the second ultrasonic sensor 2b is set to the transmitting and receiving mode. The command signal is received by the first ultrasonic sensor 2a and the second ultrasonic sensor 2b at the same time. Thus, at time T4, the first ultrasonic sensor 2a and the second ultrasonic sensor 2b operate synchronously. The first ultrasonic sensor 2a receives a reflected wave in a state where the gain and the threshold value for the receiving mode, that is, the gain and the threshold value for increasing the reception sensitivity are set. The second ultrasonic sensor 2b transmits an ultrasonic wave and receives, a reflected wave in a state where the gain and the threshold value for the transmitting and receiving mode are set.

When the ECU 3 outputs the command signal to request the detection result of the first ultrasonic sensor 2a, the first ultrasonic sensor 2a outputs the detection result at time T5. When the ECU 3 outputs the command signal to request the detection result of the second ultrasonic sensor. 2b, the second ultrasonic sensor 2b outputs the detection result at time T6. Thus, the ECU 3 can detect the distances from each of the ultrasonic sensors 2a and 2b to the obstacle in a case where the ultrasonic wave is transmitted from the second ultrasonic sensor 2a.

As described above, the obstacle detection apparatus can detect the distance from each of the ultrasonic sensors 2a and 2b to the obstacle in the case where the ultrasonic wave is transmitted from the first ultrasonic sensor 2a and in the case where the ultrasonic wave is transmitted from the second ultrasonic sensor 2b. Thus, when an obstacle exists in one of the detection areas D1a, D1b, Dc, and Db, as shown in FIG. 4A, the obstacle detection apparatus can detect the distance from one of ultrasonic sensors 2a and 2b to the obstacle. When an obstacle exists in the detection area D2, the obstacle detection apparatus can detect the distances from both of the ultrasonic sensors 2a and 2b to the obstacle. Therefore, the obstacle detection apparatus can specify the position of the obstacle.

As described above, in the obstacle detection apparatus according to the present embodiment, one of the ultrasonic sensors 2a and 2b is set to the transmitting and receiving mode and the other one is set to the receiving mode, and the reception sensitivity of the other one, which is set to the receiving mode, is increased. Thus, the area D2 where an obstacle can be detected by both the adjacent ultrasonic sensors 2a and 2b expands, and the obstacle detection apparatus can specify a position of an obstacle over a larger area.

In addition, since the area D2 can expand, the obstacle detection apparatus can warn not only that an obstacle exists in the rear of the vehicle 1 but also the specific position of the obstacle. For example, the way of warning can be changed in accordance with the position of the obstacle. The gain and the threshold value may also be set so that the areas D1a, D1b, and D2 have the same width in the left-right direction, that is, in a direction in which the first ultrasonic sensor 2a and the second ultrasonic sensor 2b are arranged, and thereby the detection area may be divided into three.

### Second Embodiment

An obstacle detection apparatus according to a second embodiment of the present invention will now be described. The obstacle detection apparatus according to the present embodiment compensates a property variation between the ultrasonic sensor 2a and the ultrasonic sensor 2b. The other parts of the obstacle detection apparatus according to the present embodiment may be similar to those of the obstacle detection apparatus according to the first embodiment. Therefore, a part different from the first embodiment will be mainly described.

In general, sound pressures and the reception sensitivities of microphones vary among ultrasonic sensors. Thus, before shipping the ultrasonic sensors, the reception sensitivities are adjusted so that the variations of the sound pressures are compensated and each of the ultrasonic sensors have the same detection area. For example, in a case where a sound pressure of an ultrasonic sensor is larger than a predetermined sound pressure, a reception sensitivity of the ultrasonic sensor is decreased. In a case where a sound pressure of an ultrasonic sensor is less than the predetermined sound pressure, a reception sensitivity of the ultrasonic sensor is increased. The above-described adjustment is called a total sensitivity compensation.

However, even if the ultrasonic sensors are treated with the total sensitivity compensation, the ultrasonic sensors can have the same detection area only when transmitting an ultrasonic wave and receiving a reflected wave are performed by the same ultrasonic sensor. When the reflected wave is received by another ultrasonic sensor, a detection area may be smaller or larger than a predetermined detection area.

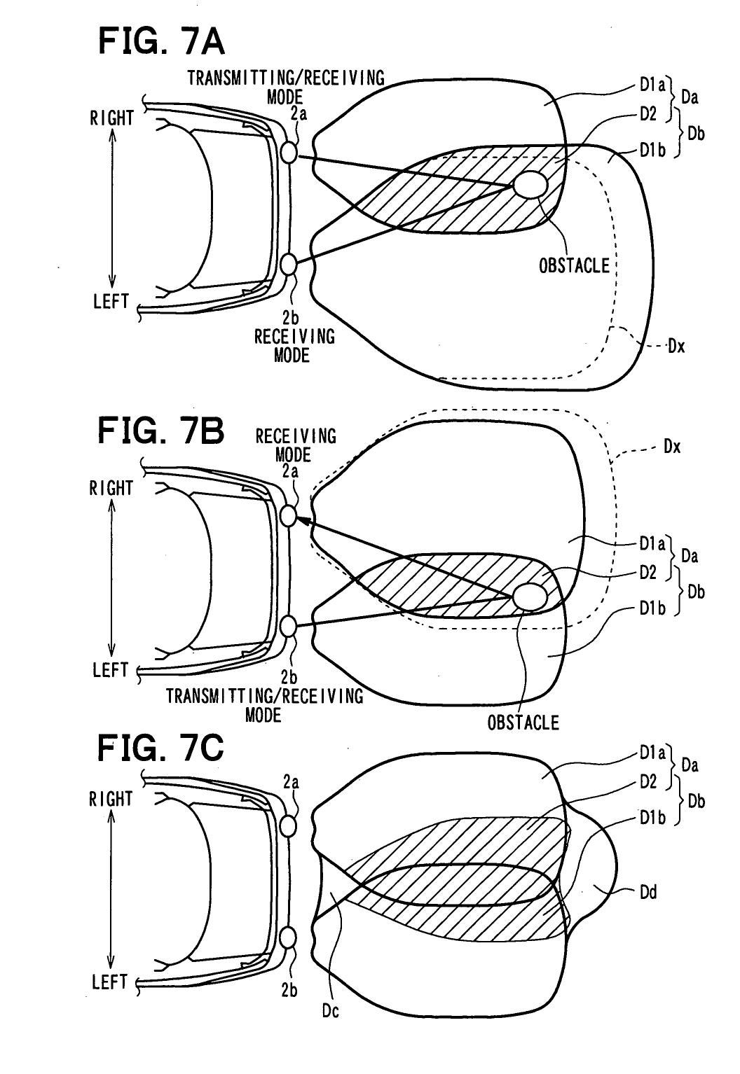

Examples of the detection areas in cases where the sound pressures and the reception sensitivities of the first ultrasonic sensor 2a and the second ultrasonic sensor 2b are different from the predetermined values are shown in FIG. 7A to FIG. 7C.

When an ultrasonic wave is transmitted from the first ultrasonic sensor 2a in a case where the sound pressure of the first ultrasonic sensor 2a is larger than the predetermined sound pressure or in a case where the reception sensitivity of the ultrasonic sensor 2b is higher than a predetermined reception sensitivity, the detection area Da of the first ultrasonic sensor 2a becomes same as a predetermined area that is set at the total sensitivity compensation, as shown in FIG. 7A. However, the detection area Db of the second ultrasonic sensor 2b becomes larger than the predetermined area Dx show by the dashed line.

In contrast, when an ultrasonic wave is transmitted from the second ultrasonic sensor 2b in a case where the sound pressure of the first ultrasonic sensor 2a is smaller than the predetermined sound pressure or in a case where the reception sensitivity of the ultrasonic sensor 2b is lower than the predetermined reception sensitivity, the detection area Db of the ultrasonic sensor 2b becomes same as the predetermined area as shown in FIG. 7B. However, the detection area Da of the first ultrasonic sensor 2a becomes smaller than the predetermined area Dx show by the dashed line.

Thus, in the total detection areas obtained in the cases shown in FIG. 7A and FIG. 7B, the area D2 where an obstacle can be detected by the two adjacent ultrasonic sensors 2a and 2b, the short distance area Dc and the long distance area Dd are distorted to the first ultrasonic sensor 2a, that is, to the right side of the vehicle.

For restricting the distortion of the detection area, the obstacle detection apparatus according to the present embodiment increases the reception sensitivity of one of the ultrasonic sensors 2a and 2b that is set to the receiving mode with taking into a consideration a variation of the sound pressure of the other one of the ultrasonic sensors 2a and 2b that is set to the transmitting and receiving mode and a variation of the reception sensitivity of the one of the ultrasonic sensors 2a and 2b that is set to the receiving mode.

For example, in a case where one of the ultrasonic sensors 2a and 2b that is set to the receiving mode has a reception sensitivity lower than the predetermined reception sensitivity or in a case where the other one of the ultrasonic sensors 2a and 2b that is set to the transmitting and receiving mode has a sound pressure larger than the predetermined sound pressure, the obstacle detection apparatus decreases an increasing amount of the reception sensitivity. In contrast, in a case where one of the ultrasonic sensors 2a and 2b that is set to the receiving mode has a reception sensitivity higher than the predetermined reception sensitivity or in a case where the other one of the ultrasonic sensors 2a and 2b that is set to the transmitting and receiving mode has a sound pressure smaller than the predetermined sound pressure, the obstacle detection apparatus increases an increasing amount of the reception sensitivity.

For example, the gain of the amplifier 11 of one of the ultrasonic sensors 2a and 2b that is set to the receiving mode can be expressed as formula (I).

A gain for the receiving mode=a gain for the transmitting and receiving mode+a gain corresponding to a predetermined increased amount of the reception sensitivity+an compensation amount (1)

The compensation amount=a sound pressure of own transmission wave−a sound pressure of the transmission wave of the adjacent ultrasonic sensor (2)

The gain for the receiving mode is the gain of the amplifier 11 when the receiving mode is set, and is set during the process at S150 in FIG. 5. The gain for the transmitting and receiving mode is the gain of the amplifier 11 when the transmitting and receiving mode is set, and is set during the process at S130 in FIG. 5. The predetermined increased amount of the reception sensitivity is the increased amount of the reception sensitivity in a case where it is assumed that each of the ultrasonic sensors 2a and 2b has the predetermined sound pressure and the predetermined reception sensitivity. The compensation amount is determined based on the variation of the sound pressure of one of the ultrasonic sensors 2a and 2b that is set to the transmitting and receiving mode and the variation of the reception sensitivity of the one of the ultrasonic sensors 2a and 2b that is set to the receiving mode.

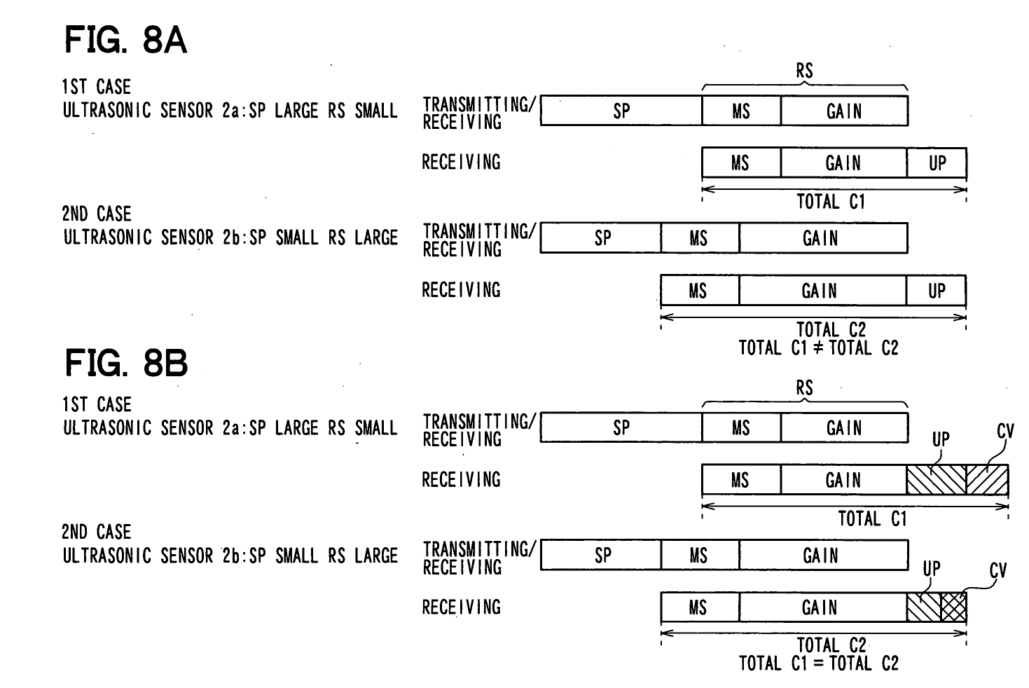

The meaning of the above-described formulas will be described with reference to FIG. 8A and FIG. 8B.

When each of the ultrasonic sensors 2a and 2b is set to the transmitting and receiving mode, the total sensitivity compensation can be expressed as the sum of the sound pressure (SP) of the transmission wave, a sensitivity (MS) of the microphone 7, and a reception gain (GAIN) for determining the reception sensitivity of for the reflected wave. If it is assumed that the sensitivity of the microphone 7 is the same, when the sound pressure of the transmission wave is larger than the predetermined sound pressure, the reception gain is set to be small as shown in a first case of FIG. 8A. When the sound pressure of the transmission wave is smaller than the predetermined sound pressure, the reception gain is set to be large as shown in a second case of FIG. 8A. Thus, the total of the sound pressure of the transmission wave, the sensitivity of the microphone 7, and the reception gain is the same between the first case and the second case.

When each of the ultrasonic sensors 2a and 2b is set to the receiving mode, the reception gain (GAIN) is increased by a predetermined increased gain (UP) corresponding to the predetermined increased amount of the reception sensitivity. Thus, when each of the ultrasonic sensor sensors 2a and 2b is set to the receiving mode, a total C1 of the sensitivity (MS) of the microphone 7, the reception gain (GAIN) and the predetermined increased gain (UP) in the first case is not same as a total C2 of the sensitivity (MS) of the microphone 7, the reception gain (GAIN) and the predetermined increased gain (UP) in the second case. That is, the total C1≠the total C2.

The total sensitivity compensation according to the present embodiment when each of the ultrasonic sensors 2a and 2b is set to the transmitting and receiving mode can be expressed as the sum of the sound pressure (SP) of the transmission wave, the sensitivity (MS) of the microphone 7, and the reception gain (GAIN) in a manner similar to the above-described example. However, the total sensitivity compensation according to the present embodiment when each of the ultrasonic sensors 2a and 2b is set to the receiving mode can be expressed as the sum of the sensitivity (MS) of the microphone 7, the reception gain (GAIN), the predetermined increased gain (UP), and a compensation value (CV). Thus, as shown in FIG. 8B, the total C1 of the sensitivity of the microphone 7, the reception gain, the predetermined increased gain and the compensation value in the first case is same as the total C2 of the sensitivity of the microphone 7, the reception gain, the predetermined increased gain, and the compensation value in the second case. Thus, even if the sound pressure of one of the ultrasonic sensor 2a and 2b is larger than or smaller than the predetermined pressure, distortion of the overlapping area D2, the short distance area Dc and the long distance area Dd can be restricted by compensating the gain for the receiving mode of the other one of the ultrasonic sensors 2a and 2b.

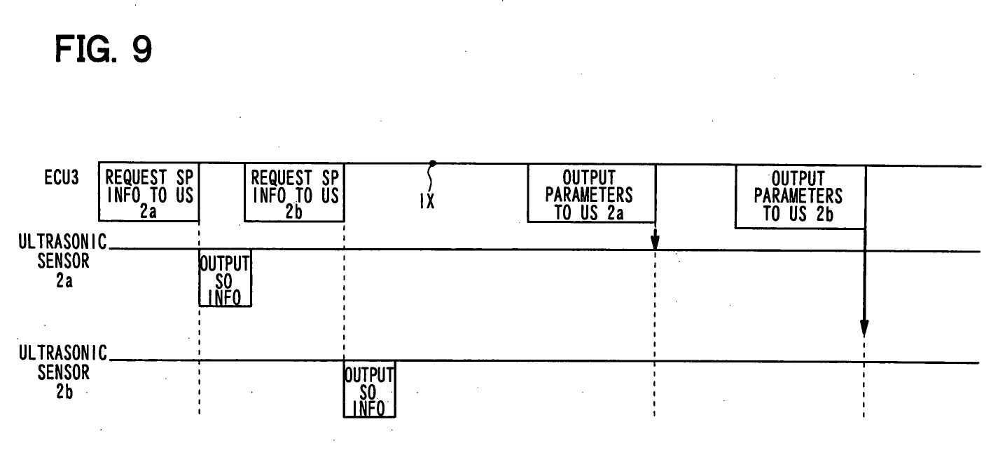

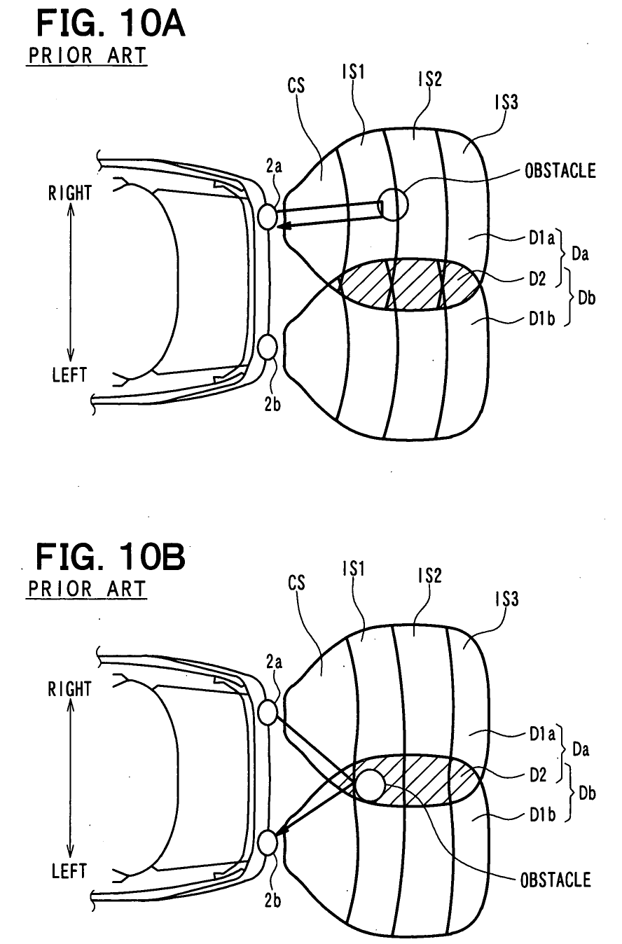

An exemplary initial operation of the obstacle detection apparatus according to the present embodiment will be described with reference to FIG. 9.

First, the ECU 3 outputs a command signal for requesting the information about the sound pressure (SP INFO) to the first ultrasonic sensor (US) 2a, and the first ultrasonic sensor 2a outputs a response signal including the information about the sound pressure. Next, the ECU 3 outputs a command signal for requesting the information about the sound pressure (SP INFO) to the second ultrasonic sensor (US) 2b, and the second ultrasonic sensor 2b outputs a response signal including the information about the sound pressure. At a point IX, the ECU 3 calculates the compensation value of each of the ultrasonic sensors 2a and 2b based the formula (1). Then, the ECU 3 outputs various parameters including the compensation value, the gain for the transmitting and receiving mode, and the gain for the receiving mode to the first ultrasonic sensor 2a and the second ultrasonic sensor 2b in order. Each of the ultrasonic sensors 2a and 2b stores the various parameters including the compensation value in the storage medium 14. When the control block 9 executes an obstacle detection process, the control block 9 reads the parameters stored in the storage medium 14 and adjust the reception sensitivity. The obstacle detection process according to the present embodiment may be similar to the obstacle detection process shown in FIG. 6.

As described above, in the obstacle detection apparatus according to the present embodiment, when the reception sensitivity is increased for the receiving mode, the compensation value based on the sound pressure of each of the ultrasonic sensors 2a and 2b is used in addition to the predetermined increased gain. Thus, the variations between the ultrasonic sensors 2a and 2b can be compensated. Therefore, even if the sound pressure of one of the ultrasonic sensors 2a and 2b is larger than or smaller than the predetermined sound pressure, distortion of the overlapping area D2, the short distance area Dc and the long distance area Dd can be restricted by compensating the gain for the receiving mode of the other one of the ultrasonic sensors 2a and 2b.

### Other Embodiments

Although the present invention has been fully described in connection with the exemplary embodiments thereof with reference to the accompanying drawings, it is to be noted that various changes and modifications will become apparent to those skilled in the art.

For example, in the second embodiment, the gain of the amplifier 11 is compensated for compensating the variation between the ultrasonic sensors 2a and 2b. The variation between the ultrasonic sensors 2a and 2b may also be compensated by compensating the threshold value of the comparator 12. In this case, a compensation value is calculated by converting the difference between the sound pressure of the first ultrasonic sensor 2a and the sound pressure of the second ultrasonic sensor 2b into a threshold value. Then, when the threshold value of one of the ultrasonic sensors 2a and 2b that is set to the receiving mode is decreased for increasing the reception sensitivity, the decreased amount of the threshold value is set with taking into consideration the compensation value. In other words, the reception sensitivity for the receiving mode is increased by subtracting a predetermined threshold value and the compensation value converted into the threshold value from the threshold value for the transmitting and receiving mode.

Alternatively, the sensitivity of the microphone 7 in the first ultrasonic sensor 2a and the sensitivity of the microphone 7 in the second ultrasonic sensor 2b may be assumed as substantially the same, and a compensation value may be calculated from the difference between the gains for the transmitting and receiving mode of the ultrasonic sensors 2a and 2b, and the gains for the receiving mode may be compensated with the compensation value. Also in this case, effects similar to the effects of the second embodiment can be obtained.

Each of the obstacle detection apparatuses according to the above-described embodiments includes the two ultrasonic sensors 2a and 2b, as examples. An obstacle detection apparatus may also include more than two ultrasonic sensors. In such a case, the above-described embodiments may be applied to adjacent two ultrasonic sensors.

In each of the obstacle detection apparatuses according to the above-described embodiments, the first ultrasonic sensor 2a and the second ultrasonic sensor 2b are daisy chained in such a manner that the first ultrasonic sensor 2a is coupled with the ECU 3 through the second ultrasonic sensor 2b. Alternatively, each of the first ultrasonic sensors 2a and the second ultrasonic sensor 2b may be directly coupled with the ECU 3 by a star connection.

What is claimed is:

1. An obstacle detection apparatus comprising:
a first ultrasonic sensor and a second ultrasonic sensor, each of the ultrasonic sensors including a microphone, the microphone configured so that the microphone transmits an ultrasonic wave and receives a reflected wave that is the ultrasonic wave reflected by an obstacle when a transmitting and receiving mode is set, and the microphone only receives the reflected wave when a receiving mode is set, each of the ultrasonic sensors having a reception sensitivity to the reflected wave, each of the ultrasonic sensors further including a reception sensitivity control portion configured to increase the reception sensitivity when the receiving mode is set compared with when the transmitting and receiving mode is set;
a control part configured so that the control part sets the first ultrasonic sensor to the transmitting and receiving mode while setting the second ultrasonic sensor to the receiving mode, and then sets the first ultrasonic sensor to the receiving mode while setting the second ultrasonic sensor to the transmitting and receiving mode; and
a warning device configured to warn in accordance with a distance between at least one of the ultrasonic sensors and the obstacle.

2. The obstacle detection apparatus according to claim 1, wherein the first ultrasonic sensor and the second ultrasonic sensor are arranged in a direction and the first ultrasonic sensor and the second ultrasonic sensor are configured so that:
when the first ultrasonic sensor is set to the transmitting and receiving mode and the second ultrasonic sensor is set to the receiving mode, only the first ultrasonic sensor is capable of detecting an obstacle in a first area;
when the first ultrasonic sensor is set to the receiving mode and the second ultrasonic sensor is set to the transmitting and receiving mode, only the second ultrasonic sensor is capable of detecting an obstacle in a second area;
both of the first ultrasonic sensor and the second ultrasonic sensor are capable detecting an obstacle in a third area; and
the first area, the second area, and the third area have substantially the same width in the direction in which the first ultrasonic sensor and the second ultrasonic sensor are arranged.

3. The obstacle detection apparatus according to claim 1, wherein:
the first ultrasonic sensor includes a storage medium storing information about a sound pressure of the ultrasonic wave transmitted from the microphone of the first ultrasonic sensor;
the second ultrasonic sensor includes a storage medium storing information about a sound pressure of the ultrasonic wave transmitted from the microphone of the second ultrasonic sensor; and
the reception sensitivity control portion is configured to compensate the reception sensitivity when the receiving mode is set based on a compensation value calculated from a difference between the sound pressures.

4. The obstacle detection apparatus according to claim 4, wherein:
each of the ultrasonic sensors includes an amplifier and a comparator;
the amplifier is configured to amplify the reflected wave received by the microphone with a gain;
the comparator configured to detect that the microphone receives the reflected wave by comparing the reflected wave amplified by the amplifier with a threshold value; and
the reception sensitivity control portion is configured to increase the reception sensitivity when the receiving mode is set by at least one of increasing the gain and decreasing the threshold value compared with when the transmitting and receiving mode is set.

5. The obstacle detecting apparatus according to claim 4, wherein:
the compensation value for the first ultrasonic sensor is calculated by subtracting the sound pressure of the second ultrasonic sensor from the sound pressure of the first ultrasonic sensor;
the compensation value for the second ultrasonic sensor is calculated by subtracting the sound pressure of the first ultrasonic sensor from the sound pressure of the second ultrasonic sensor; and
the reception sensitivity control portion is configured to increase the reception sensitivity when the receiving mode is set by increasing the gain of the amplifier 11 to a sum of the gain when the transmitting and receiving mode is set, a gain corresponding to a predetermined increased amount of the reception sensitivity, and the compensation value.

6. The obstacle detecting apparatus according to claim 5, wherein:
the control part receives the information about the sound pressures from the first ultrasonic sensor and the second ultrasonic sensor, calculates the compensation values from the sound pressures, transmits the compensation value for the first ultrasonic sensor to the first ultrasonic sensor, and transmits the compensation value for the second ultrasonic sensor to the second ultrasonic sensor;
each of the ultrasonic sensors stores the compensation value in the storage medium; and
the reception sensitivity control portion reads the compensation value stored in storage medium when the reception sensitivity control portion increases the reception sensitivity.

7. The obstacle detecting apparatus according to claim 4, wherein
the compensation value for the first ultrasonic sensor is calculated by subtracting the sound pressure of the second ultrasonic sensor from the sound pressure of the first ultrasonic sensor;
the compensation value for the second ultrasonic sensor is calculated by subtracting the sound pressure of the first ultrasonic sensor from the sound pressure of the second ultrasonic sensor; and
the reception sensitivity control portion increases the reception sensitivity when the receiving mode is set by subtracting a threshold value corresponding to a predetermined increased amount of the reception sensitivity and the compensation value from the threshold value of the comparator when the transmitting and receiving mode is set.

8. A method of controlling an obstacle detection apparatus including a first ultrasonic sensor and a second ultrasonic sensor, comprising:
setting the first ultrasonic sensor to a transmitting and receiving mode while setting the second ultrasonic sensor to a receiving mode so that the first ultrasonic sensor transmits a first ultrasonic wave and the first ultrasonic sensor and the second ultrasonic sensor receive a first reflected wave that is the first ultrasonic wave reflected by an obstacle, the setting the first ultrasonic sensor to the transmitting and receiving mode including setting a reception sensitivity of the first ultrasonic sensor to a first reception sensitivity for the transmitting and receiving mode, the setting the second ultrasonic sensor to the receiving mode including setting a reception sensitivity of the second ultrasonic sensor to a second reception sensitivity for the receiving mode;
calculating a distance from the first ultrasonic sensor to the obstacle based on a time from when the first ultrasonic wave is transmitted from the first ultrasonic sensor till when the first reflected wave is received by the first ultrasonic sensor;
calculating a distance from the second ultrasonic sensor to the obstacle based on a time form when the first ultrasonic wave is transmitted from the first ultrasonic sensor till when the first reflected wave is received by the second ultrasonic sensor;
setting the first ultrasonic sensor to the receiving mode while setting the second ultrasonic sensor to the transmitting and receiving mode so that the second ultrasonic sensor transmits a second ultrasonic wave and the first ultrasonic sensor and the second ultrasonic sensor receive a second reflected wave that is the second ultrasonic wave reflected by the obstacle, the setting the first ultrasonic sensor to the receiving mode including setting the reception sensitivity of the first ultrasonic sensor to a first reception sensitivity for the receiving mode, the setting the second ultrasonic sensor to the transmitting and receiving mode including setting the reception sensitivity of the second ultrasonic sensor to a second reception sensitivity for the transmitting receiving mode;
calculating a distance from the first ultrasonic sensor to the obstacle based on a time from when the second ultrasonic wave is transmitted from the second ultrasonic sensor till when the second reflected wave is received by the first ultrasonic sensor;
calculating a distance from the second ultrasonic sensor to the obstacle based on a time form when the second ultrasonic wave is transmitted from the second ultrasonic sensor till when the second reflected wave is received by the second ultrasonic sensor;
detecting a position of the obstacle based on the distances, wherein
the first reception sensitivity for the receiving mode is higher than the first reception sensitivity for the transmitting and receiving mode, and the second reception sensitivity for the receiving mode is higher than the second reception sensitivity for the transmitting and receiving mode.

9. The method according to claim 8, wherein:
the first reception sensitivity for the receiving mode is a sum of the first reception sensitivity for the transmitting and receiving mode, a predetermined increased amount, and a first compensation value;
the second reception sensitivity for the receiving mode is a sum of the second reception sensitivity for the transmitting and receiving mode, the predetermined increased amount, and a second compensation value;
the first compensation value is calculated by subtracting a sound pressure of the second ultrasonic wave transmitted from the second ultrasonic sensor from a sound pressure of the first ultrasonic wave transmitted from the first ultrasonic sensor; and
the second compensation value is calculated by subtracting the sound pressure of the first ultrasonic wave transmitted from the first ultrasonic sensor from the sound pressure of the second ultrasonic wave transmitted from the second ultrasonic sensor.
